(19) United States
(12) Patent Application Publication
(10) Pub. No.: US 2024/0233443 A1
(43) Pub. Date: Jul. 11, 2024

(54) Training One or More Machine Learning Models to Recognize One or More Movements Using Virtual Actors and Virtual Cameras

(71) Applicant: Coulter Ventures LLC, Columbus, OH (US)

(72) Inventors: Darren Rush, Columbus, OH (US); Larry Hignight, Columbus, OH (US); Glenn Marcus, Columbus, OH (US); Michal tyczek, Columbus, OH (US)

(21) Appl. No.: 18/561,640

(22) PCT Filed: Apr. 15, 2022
(86) PCT No.: PCT/US22/25062

§ 371 Date: Nov. 16, 2023

Related U.S. Application Data
(60) Provisional application No. 63/175,178, filed on Apr. 15, 2021.

(51) Int. Cl. G06V 40/20; G06N 3/08; G06V 10/774; G06V 10/82

(52) U.S. Cl. CPC G06V 40/23; G06N 3/08; G06V 10/774; G06V 10/82

(57) ABSTRACT

The present disclosure describes generating synthetic training data for a machine learning model to detect one or more movements. The training data comprises a virtual actor (e.g., a 3D model of a skeleton, a 3D model of human, or a wireframe) posed in a plurality of positions and one or more virtual cameras may be used to capture each of the plurality of positions. The images of each of the plurality of positions may be used as synthetic training data for a machine learning model. The machine learning model may be trained to recognize a repetitive motion being performed by a non-virtual actor (e.g., a human) and count repetitions and provide feedback with respect to form.

### CROSS-REFERENCE TO RELATED APPLICATIONS

This application claims priority to U.S. Provisional Application No. 63/175,178, filed on Apr. 15, 2021 and entitled “Virtual Actors for Optimum Post Training Data Generation for Use with One or More Machine Learning Models,” the entirety of which is incorporated herein by reference for all purposes.

### FIELD OF USE

Aspects of the disclosure relate generally to machine learning and, more specifically to training machine learning models using information obtained from one or more virtual cameras. Additionally, aspects of the disclosure describe using the machine learning models to detect movements and/or provide feedback to a user to correct their form and improve performance.

### BACKGROUND

In order to train machine learning models to correctly identify people in specific body positions, example training data is needed that expresses a range of variability for how the position may be viewed in a live application. Traditionally, training data for body position would be captured by editing selections of live actors in example poses. In real-world applications, users will be found in a variety of orientations. For example, the user may not be centrally positioned in a frame, some body parts may be out of frame, the user's body may be rotated or not directly facing the camera, etc. Training a machine learning model to recognize these variance requires training data for each scenario. As an example, capturing these variances would require multiple videos and/or images accounting for each variance. Capturing images and/or videos of live actors in these situations, and labelling the data correctly, is both costly and time consuming. Moreover, some variances may be missed, which may cause the machine learning model to not recognize and/or misidentify the body position. Furthermore, existing machine learning models are limited to detecting single movements and cannot recognize or detect movements or compound workouts, such as superset workouts where an athlete alternates sets of at least two different exercises.

### SUMMARY

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

The methods, devices, systems, and/or computer-readable media described herein generate synthetic training data, to train one or more machine learning models, using virtual actors (e.g., a 3-dimensional (3D) model of a skeleton, a 3D model of human, or a wireframe) in 3D environments. Additionally, the techniques described herein use one or more virtual cameras to capture the virtual actors. This provides a full range of scene variability and/or body positioning, which overcomes limitations with existing techniques that employ physical cameras that are limited in what they capture. In this regard, the synthetic training data may capture a full frame of an actor (e.g., virtual actor or non-virtual actor) as a video or one or more images from a variety of angles and/or perspectives. With the full body in frame, body pose data may be estimated and provided to one or more machine learning models so that the one or more machine learning models may recognize and/or classify a first position or first movement and differentiate the first position or first movement from other subsequent positions and/or movements, as well as different positions and/or movements.

The techniques described herein may begin with generating a virtual actor (e.g., a 3-dimensional (3D) model of a skeleton, a 3D model of human, or a wireframe) in a virtual environment. The virtual actor may be posed, or positioned, in a first pose for detection (e.g., machine learning classification). One or more virtual cameras may be positioned around the virtual actor to capture the first pose. In some examples, the one or more virtual cameras and/or the virtual actor may be rotated and/or repositioned to capture one or more variances in the first pose, for example, from different angles and/or perspectives. The one or more virtual cameras may also capture instances where the virtual actor is not centered in the frame or is partially in frame. The resulting videos, animations, and/or sequence of frame images may be labelled and provided to one or more machine learning models as training data.

The one or more machine learning models may use the training data to learn how to recognize and/or classify one or more movements and/or repetitive motions of a non-virtual actor (e.g., a human). Additionally or alternatively, the one or more machine learning models may be trained to recognize one or more objects, such as barbells, dumbbells, kettlebells, and/or any other suitable gym equipment. The one or more objects may also comprise other objects, such as dance equipment, physical therapy equipment, boxes, etc. By training the one or more machine learning models to detect objects, the one or more machine learning models may be able to more accurately identify a movement being performed by a non-virtual actor.

After being trained, the one or more machine learning models may be incorporated into an application, such as a mobile application (“app”), configured to provide users with one or more guided workouts. The application may execute on a computing device, such as a mobile device (e.g., a smart phone, a tablet, etc.). The application may provide the non-virtual actor (e.g., user) with a first movement as part of the guided workout. The application may use the one or more machine learning models and one or more cameras associated with the computing device to detect a movement being performed by the non-virtual actor. The application, using the one or more machine learning models and using the one or more cameras, may detect a starting position, a mid-position, and/or an ending position of a movement. Based on detecting the various positions of the movement, the application may recognize a movement, count repetitions of the movement, and/or provide feedback to improve the user's form of the movement. Further, the app may detect when the non-virtual actor changes movements, either as part of the guided workout or based on the actions of the non-virtual actor.

By using virtual actors and one or more virtual cameras to train the one or more machine learning models, the application may be able to recognize a movement performed by the non-virtual actor regardless of the placement of computing device and/or the angle or perspective of the one or more cameras. That is, the use of the virtual actors and one or more virtual cameras may create a more diverse set of training data that would allow the one or more machine learning models to recognize movements from any angle or perspective. Additionally, the one or more machine learning models may recognize movements when the non-virtual actor is not centered in a frame of the one or more cameras. This improves over existing technologies, which require specific placement of a device and/or the user to be centered in a frame of an image.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 shows an example of a system in which one or more features described herein may be implemented;

FIG. 2 shows an example computing device;

FIG. 3 shows a flow chart of a process for generating training data in accordance with one or more aspects of the disclosure;

FIGS. 4A-4C show an example of generated training data according to one or more aspects of the disclosure;

FIG. 5A-5B shows another example of training data generated in accordance with one or more aspects of the disclosure;

FIG. 6 shows an example of a process for the development of a machine learning model in accordance with one or more aspects of the disclosure;

FIG. 7 shows a flow chart of a process for training a machine learning model using the generated training data in accordance with one or more aspects of the disclosure;

FIG. 8 shows an example of a process for recognizing movements in accordance with one or more aspects of the disclosure;

FIG. 9 shows an example of the machine learning model recognizing a position according to one or more aspects of the disclosure;

FIG. 10 shows an example of an application using the machine learning model in accordance with one or more aspects of the disclosure;

FIG. 11 shows an example of performing a plurality of movements in accordance with one or more aspects of the disclosure; and

FIG. 12 shows an example process 1200 for detecting missed repetitions in accordance with one or more aspects of the disclosure.

### DETAILED DESCRIPTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to methods, devices, systems, and/or computer-readable media for generating synthetic training data using virtual actors (e.g., a 3-dimensional (3D) model of a skeleton, a 3D model of human, or a wireframe) and one or more virtual cameras in 3D environments. For example, a 3D rendering tool may be used to produce one or more images and/or videos of a 3D virtual actor in a given pose and/or position. The use of virtual actors and one or more virtual cameras allows training data to be generated from a variety of angles and/or perspectives. In this regard, the virtual actor may be posed, or positioned, in a first pose for classification. The one or more virtual cameras may be positioned around the virtual actor to capture the first pose. The one or more virtual cameras may capture the virtual actor in the first pose from different angles and/or perspectives. In some instances, the one or more virtual cameras and/or the virtual actor may be rotated and/or repositioned to capture one or more variances in the first pose. Accordingly, the one or more virtual cameras may obtain images of the virtual actor in a first pose from a 360-degree perspective. Additionally, the one or more virtual cameras may be positioned and/or re-positioned at different locations and/or elevations, such as, from a floor level, chest height of the user, or an elevated view of the user. The one or more virtual cameras may obtain images of the virtual actor in the first pose from the different locations and/or at a plurality of elevations (e.g., from the floor, at eye-level, above the virtual actor, etc.). The one or more images and/or videos captured by the one or more virtual cameras may provide 360° angles of the first pose. An example video may be captured at 30 frames per second and run for 12 seconds for 1 complete revolution and/or rotation of the virtual actor. In this case, each frame of the example video may represent 1° of rotation. Each frame may be provided to one or more machine learning models, as training data, with a label of the first pose. This would allow the one or more machine learning models to see a possible actor in the first pose from a 360° perspective. Additionally, the one or more machine learning models may be trained to recognize one or more objects and/or gym equipment. By including objects in the analysis, the one or more machine learning models may be able to identify a movement being performed by the non-virtual actor more accurately.

As noted above, the resulting videos, animations, and/or sequence of frame images and their associated labels may be provided to one or more machine learning models as training data. The one or more machine learning models may be trained to recognize and/or classify one or more movements and/or repetitive motions of a non-virtual actor (e.g., a human). For example, the one or more movements may comprise an exercise movement, a physical therapy movement, a rehabilitation movement, a dance routine (movement), a lifting movement (e.g., a factory worker lifting boxes), or the like. The training data may identify one or more images and/or videos showing the starting, intermediary, and finishing position of the movement. The one or more machine learning models may identify and/or recognize changes in limb length, limb velocity, joint angle, and/or joint velocity as part of identifying the movement. The one or more machine learning models may also detect changes in an object's location as part of identifying the movement. In this regard, the one or more machine learning models may be incorporated into an application, such as a mobile app, configured to provide users with guided workouts. A mobile device executing the application may recognize a movement, count repetitions of the movement, and/or provide feedback to improve the user's form of the movement.

By using virtual actors and/or virtual environments to develop synthetic training data, development time may be reduced. Moreover, the one or more machine learning models may be trained with more training data, but require less validation data once the model is trained. This results in improved efficiency and implementation of the one or more machine learning models. Furthermore, the use of the virtual actors and the one or more virtual cameras may allow the one or more machine learning models to better recognize and/or classify movements from real-time images due to the training data accounting for variance in the images, including, for example, different angles and/or perspectives of the non-virtual actor performing the movement.

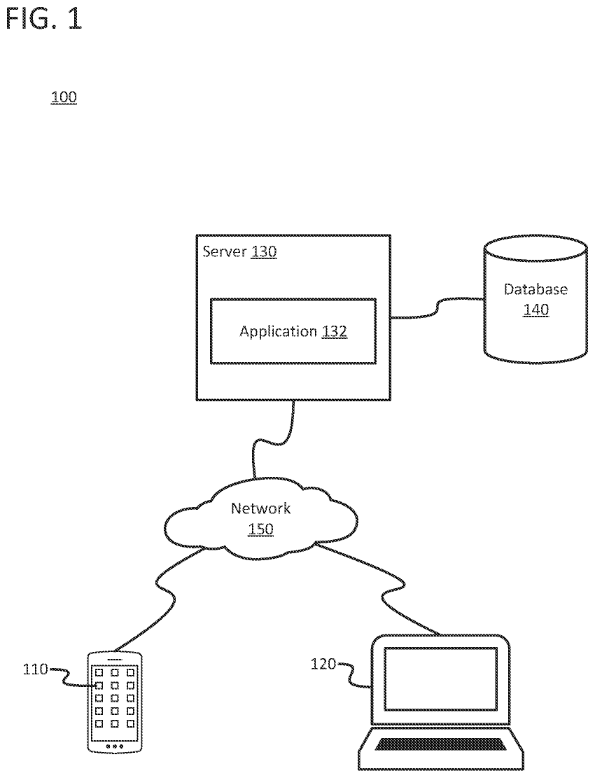

FIG. 1 shows an example of a system 100 that includes a first user device 110, a second user device 120, and a server 130, connected to a database 140, interconnected via network 150.

First user device 110 may be a mobile device, such as a cellular phone, a mobile phone, a smart phone, a tablet, a laptop, or an equivalent thereof. Additionally or alternatively, the first user device 110 may comprise dedicated hardware comprising one or more processors, memory, and/or one or more cameras configured to capture a user's performance and/or movements. The one or more cameras may comprise a 2-D camera or a stereoscopic (e.g., 3-D) camera. Additionally or alternatively, the first user device 110 may comprise one or more sensors, such as LIDAR. First user device 110 may provide a first user with access to various applications and services. For example, first user device 110 may provide the first user with access to the Internet. Additionally, first user device 110 may provide the first user with one or more applications (“apps”) located thereon. The one or more apps may provide the first user with a plurality of tools and access to a variety of services. In some embodiments, a first app, of the one or more apps, may comprise a cross-platform app that provides users with guided workouts. The first app may allow the user to create a public profile. The public profile may include an avatar, which may be used to represent the user in the guided workouts and/or competitive workouts. The first app may recommend suggested workouts and/or workout plans based on the user's fitness level, fitness goals, workout type preference, and/or available equipment. Each guided workout can be completed in solo or competitive mode. Competitive mode may match the user with a small group of real or virtual athletes to motivate and encourage maximum effort. The first app may use advanced Artificial Intelligence and/or machine learning to track workout progress and/or count repetitions (“reps”) of each exercise. The Artificial Intelligence and/or machine learning may also provide recommendations and/or suggestions to improve the first user's performance. That is, the Artificial Intelligence and/or machine learning may analyze the first user's movements and provide recommendations and/or suggestions for improving the first user's exercise regimen. Workout performance data may be captured, for example, via integrated health services, and shared with the server 130.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. In some examples, the one or more web browsers may allow the second user to access a website associated with the first app, discussed above. The website may provide the second user with guided workouts. The second user may be able to create and/or access their public profile via the website. The website may recommend suggested workouts and/or workout plans based on the second user's fitness level, fitness goals, workout type preference, and/or available equipment. The website may also may use advanced Artificial Intelligence and/or machine learning to track workout progress and/or count repetitions of movements. Workout performance data may be captured, for example, via integrated health services and/or one or more image capture devices associated with the second user device 120. The workout performance data may be stored on the server 130 and/or the database 140.

Server 130 may be any server capable of executing application 132. Additionally, server 130 may be communicatively coupled to the database 140. In this regard, server 130 may be a stand-alone server, a corporate server, or a server located in a server farm or cloud-computer environment. According to some examples, server 130 may be a virtual server hosted on hardware capable of supporting a plurality of virtual servers. In some embodiments, the server 130 may belong to a company that produces the first app and/or website described above.

Application 132 may be server-based software configured to provide users with data and/or information. Application 132 may be the server-based software that corresponds to the client-based software executing on first user device 110 and/or second user device 120. In some examples, the application 132 may be a server-side application corresponding to the first app and website described above. In this regard, the application 132 may generate synthetic training data using the techniques described herein. Moreover, the application 132 may use the synthetic training data to train one or more machine learning models. The application 132 may distribute the one or more trained machine learning models, for example, via an application, like the first app discussed above. Additionally or alternatively, the application 132 may make the one or more trained machine learning models available through a website, such as the website discussed above with respect to the second device 120.

The database 140 may be configured to store information on behalf of application 132. The information may include, but is not limited to, personal information, account information, and/or user-preferences. Additionally or alternatively, the data and/or information may comprise the training data, the one or more machine learning models, and/or any additional data and/or information that would allow the training data and/or the one or more machine learning models to be used in a commercial application. The database 140 may include, but is not limited to relational databases, hierarchical databases, distributed databases, in-memory databases, flat file databases, XML databases, NoSQL databases, graph databases, and/or a combination thereof.

The network 150 may include any type of network. In this regard, the network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

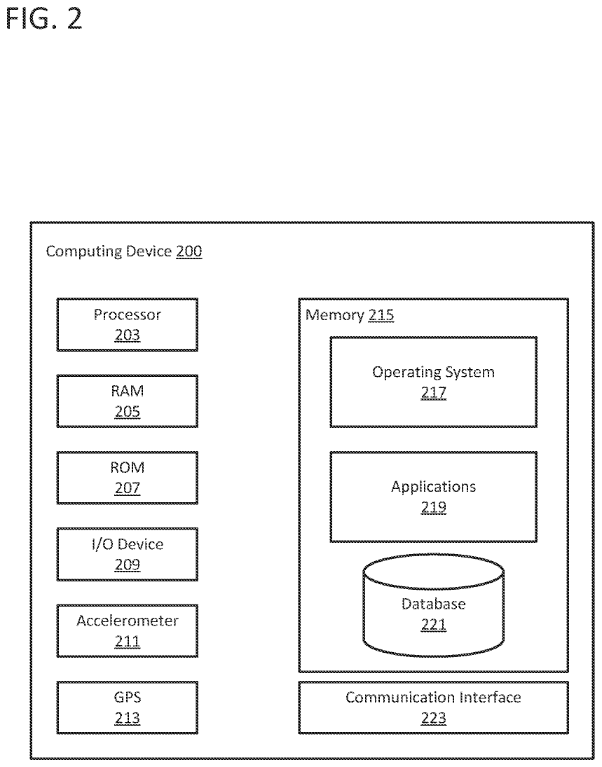

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, an image capture device (e.g., camera, video camera, etc.), keypad, touch screen, and/or stylus through which a user of the computing device 200 may provide input, and may also comprise one or more of a speaker for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

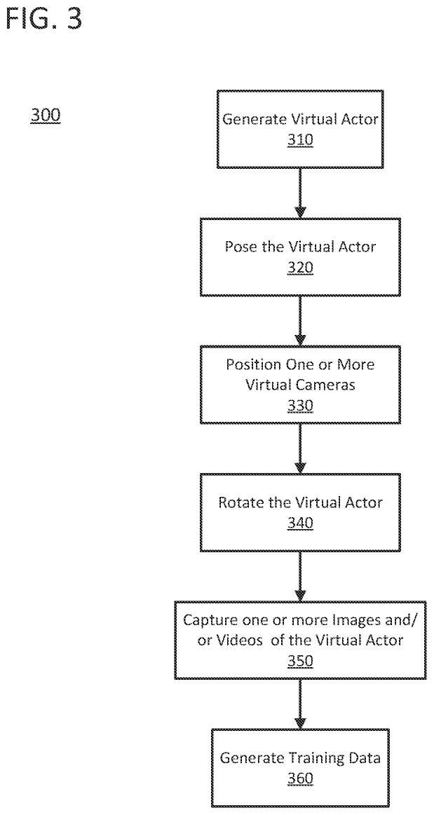

As noted above, synthetic training data may be generated to train one or more machine learning models to detect and/or recognize a movement, count repetitions of the movement, and/or analyze a user's performance to provide feedback and/or suggestions to improve the user's form, technique, and/or overall performance. FIG. 3 shows a flow chart of a process 300 for generating synthetic training data according to one or more aspects of the disclosure. Some or all of the steps of process 300 may be performed using one or more computing devices as described herein, including, for example, the first user device 110, the second user device 120, or the server 130 or any combination thereof.

In step 310, a computing device may generate a virtual actor. The virtual actor may be a 3-dimensional (3D) model or a wireframe. The 3D model may be a model of a skeleton or an animal, including humans. The wireframe may represent a wireframe representation of the animal (e.g., human). Generating the virtual actor may comprise rendering the virtual actor. Once the virtual actor is rendered, the virtual actor may be positioned in step 320. Positioning the virtual actor may comprise maneuvering and/or positioning the virtual actor into a desired body pose for detection. That is, the virtual actor may be positioned in a position for machine learning classification. Additionally or alternatively, one or more objects (e.g., weights, barbells, dumbbells, kettlebells, dance equipment, physical therapy equipment, boxes, etc.) may be included the image as an additional reference point. The virtual actor and/or the objects may be positioned in a starting position, a middle position, and/or an ending position of a movement. For example, the virtual actor may be placed in the starting, middle, and/or ending position of a movement, such as a squat, a push-up, a power clean, etc.

After the virtual actor is in a position, one or more virtual cameras may be positioned (“situated” around the virtual actor in step 330. The one or more virtual cameras may simulate one or more camera angles expected in live use. Additionally or alternatively, the one or more virtual cameras may be configured to replicate data generated by actual cameras. That is, the one or more virtual cameras may be configured to capture images and/or videos with the same settings used by real-world cameras. For example, a first virtual camera of the one or more virtual cameras may be configured to represent a smartphone camera. In this regard, the first virtual camera may a forward-facing smart phone camera, such as the 7-megapixel True Depth camera with an f/2.2 aperture found on an iPhone that is capable of capturing 1080p video at 30 frames per second (fps) or 720p video at 240 fps. Additionally or alternatively, the first virtual camera may be a rear facing camera, like the 12-megapixel wide-angle camera with f/1.8 aperture located on an iPhone that is capable of capturing 4K video at 24, 30 or 60 fps, or 1080p video at 30, 60, 120 or 240 fps. It will be appreciated that the camera settings discussed above are merely illustrative and that any suitable camera settings may be used for the virtual camera. The one or more virtual cameras may be positioned at various positions and/or elevations. Preferably, the one or more virtual cameras may be placed at positions where users would most likely place their camera while performing the movement. For example, the one or more virtual cameras may be placed on the floor, at an upward angle. Additionally or alternatively, the one or more virtual cameras may be placed at a chest height of the virtual actor. Additionally or alternatively, the one or more virtual cameras may be placed to account for variances, such as the user not being centered in the frame or the user's body being positioned away from the camera.

Once the one or more virtual cameras are positioned, the virtual actor may be rotated in-place in step 340. Additional or alternatively, the one or more virtual cameras may be rotated around the virtual actor in step 430. In some instances, the virtual actor may be animated. That is, the virtual actor may be performing the movements while the virtual actor and/or the one or more virtual cameras revolve the virtual actor. Once the virtual actor and/or the one or more virtual cameras are moving, the computing device may capture the resulting animation in step 350. The resulting animation may be captured as videos and/or sequence of frame images. This may allow the computing device to produce multiple videos of the virtual actor in a given position, from 360° angles, with cameras at different positions and/or elevations (for example floor level and chest height position). If each resultant video (e.g., animation) is 12 seconds in length for 1 complete rotation around the virtual actor and is captured at a frame rate of 30 fps, each frame may represent 1° of rotation. Each image (frame) may have a label applied thereto to. The label for each image (frame) may allow the one or more machine learning models to learn to recognize the movement. Using each frame as a training image for the model may provide the machine learning model with a 360° rotation of the virtual actor. Additionally, the resultant videos and/or animations may become easier to filter a subset of the frames. For example, if the trained model may be required to detect poses where the virtual actor is facing the camera, only the frames where the virtual actor is within −90°/+90° of facing the camera may be used for training. To further accelerate development time, training with less frames could be useful. For example, the training data may use every 10° of rotation instead of every 1° to represent at 10x time savings for training a model to vary its performance. This can be useful, for example, when experimenting with major variables or trying new modeling approaches.

In step 360, the computing device may generate the training data. Generating the training data may comprise storing the training data in a memory, such as a memory of a server. Additionally or alternatively, generating the training data may comprise exporting the animation (e.g., video, sequence of images, etc.) and the associated label(s) as training data. The training data may represent a movement or a position of a movement. The training data may have a first label identifying the movement. Additionally or alternatively, the training data may comprise a second label identifying a point (state) in the movement. For example, the second label may identify the starting position, a middle position, or the ending position of a movement. Additionally or alternatively, the training data may represent an animation of the movement to be taught to the machine learning model. Each frame of the animation or video may comprise a first label identifying the movement and a second label identifying a state (e.g., position) of the movement. For example, an animation of a squat may comprise a first label identifying the movement as a squat. The first label may be the same for each frame in the animation. The second label may identify a state (e.g., position) of the movement. For example, the second label may identify the staring position, the middle position, and/or the ending position. In practice, the second label may comprise a plurality of states identifying a middle position. Returning to the squat example, the middle position may identify states between the start position and the middle position (i.e., bottom of the squat, before the user begins rising again), such as middle position, moving down. Similarly, the middle position may identify states between the middle position and the ending position, such as middle position, moving up. It will be appreciated that these examples are merely illustrative and any number of secondary labels may be used to identify the state associated with movement.

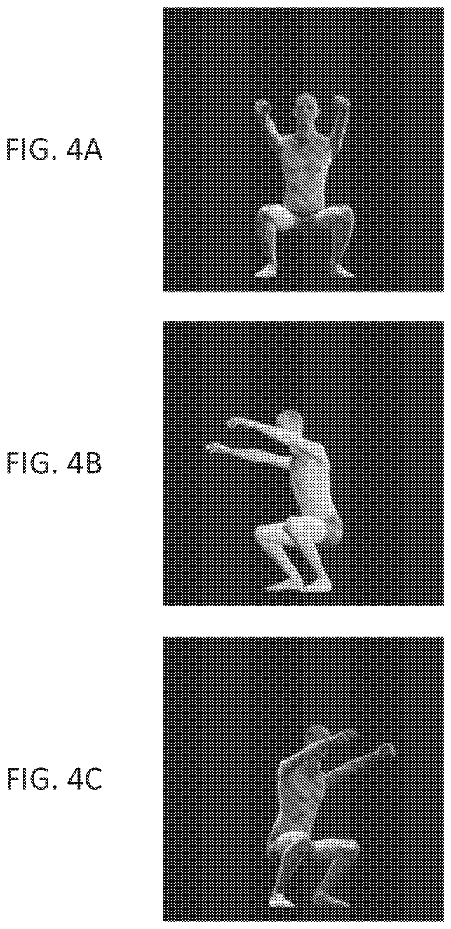

FIGS. 4A-4C shows an example of synthetic training data generated according to one or more aspects of the disclosure. In this regard, FIGS. 4A-4C show a plurality of images of a virtual actor in a mid-squat position. In this regard, FIG. 4A shows a first frame of an animation rendering of a virtual actor. The first frame shows the virtual actor in an ideal position from a virtual camera located on the floor. Accordingly, FIG. 4A shows the virtual actor from an upward facing camera. The ideal position represented by the virtual actor, and captured by the virtual camera, may represent a medically approved form of the movement. FIG. 4B shows another frame of the animation rendering. Again, the virtual camera is an upward facing camera located on a floor of the virtual environment. By rotating the virtual actor around their own axis, the virtual camera can generate and/or simulate alternate views of the virtual actor relative to the camera. we can simulate alternate rotations relative to the camera. This is a frame capturing an actor at about a 45° from front-facing. FIG. 4C shows a third frame of the animation, near the end of 360° rotation. Like FIGS. 4A and 4B above, the virtual camera is an upward facing camera located on a floor of the virtual environment to capture another frame at a rotation angle that may be encountered in the real-world. Each of the images shown in FIGS. 4A-4C may have a first label indicating a squat movement and a second label indicating a middle position of the squat. By allowing the virtual camera to capture different angles of the virtual actor, the training data, and the labels associated therewith, may be better suited to train the machine learning model to recognize, identify, derive, or extract features from one or more base features. These extracted features may include changes in limb length, limb velocity, joint angle, and/or joint velocity for various movements. This may allow the machine learning model to recognize movements more efficiently by requiring less processing power to recognize the movements.

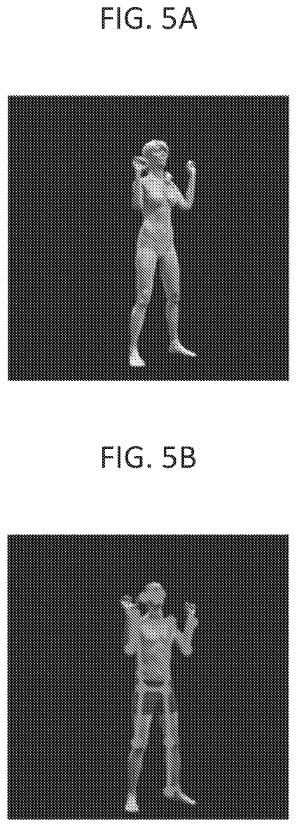

FIGS. 5A and 5B show additional examples of synthetic training data generated according to one or more aspects of the disclosure. FIG. 5A shows a female virtual actor. The virtual camera in FIG. 5A may be approximately chest-height.

Additionally, the camera is approximately 45° off center from directly facing the virtual actor. FIG. 5B shows the virtual actor with a wireframe overlay. The wireframe overlay indicates that pose data that can be extracted from virtual actors/models with similar accuracy as photos.

As described above in FIGS. 3-5B, generating the synthetic training data may comprise an iterative process. The iterative process may include placing the virtual actor in a first pose indicative of a starting position of a repetition of a movement. The first pose may include one or more objects, such as barbells, dumbbells, kettlebells, etc. The one or more objects may also comprise other objects, such as dance equipment, physical therapy equipment, boxes, etc. Once the virtual actor is in the first pose, a first plurality of images may be captured using one or more virtual cameras, a first plurality of images of the virtual actor in the first pose. As described above, each of the first plurality of images may be captured from different angles and/or different perspectives. Further, each of the first plurality of images may apply one or more labels to the first plurality of images. As noted above, a first label may indicate the movement, while a second label may indicate a state (position) of the virtual actor. Once the first plurality of images are labelled, the virtual actor may be placed in a second pose indicative of a mid-point of the repetition of the movement. A second plurality of images may be captured using the one or more virtual cameras. Labels may be applied to each of the second plurality of images, similar to how the labels were applied to the first plurality of images. After the second plurality of images are labelled, the virtual actor may be posed in a third position, indicative of of a finishing position of the repetition of the movement. A third plurality of images may be captured using the one or more virtual cameras, with each of the third plurality of images receiving one or more labels. The iterative process described herein provides a vast array of information to the one or more machine learning models that enable the one or more machine learning models to identify the movement quicker than using traditional machine learning training techniques.

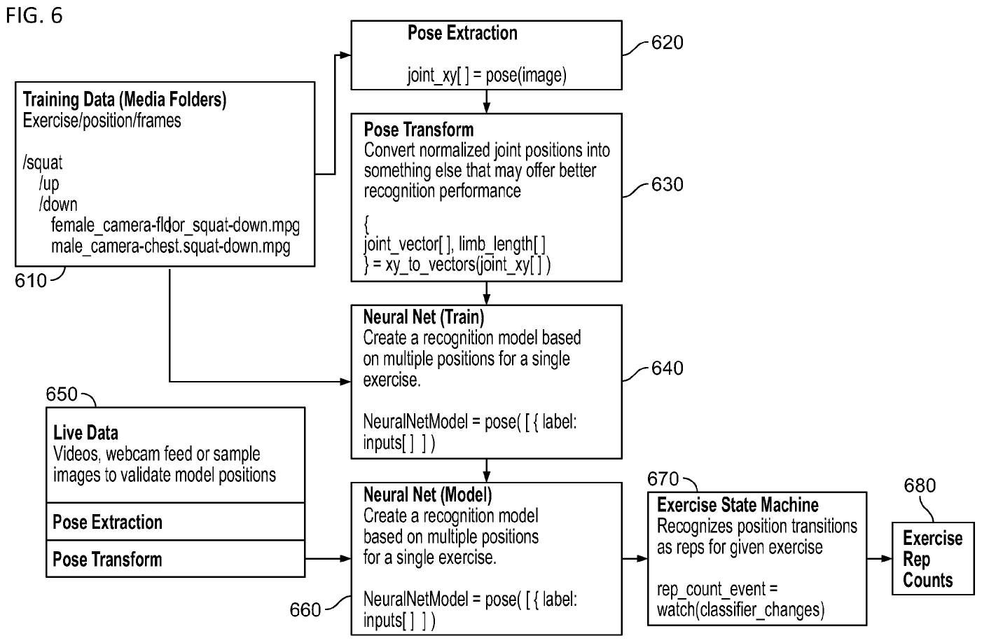

Once the synthetic training data is generated, the synthetic training data may be used to train one or more machine learning models to recognize movements. FIG. 6 shows an example of a process for the development of a machine learning model in accordance with one or more aspects of the disclosure. In step 610, a computing device may generate synthetic training data. The synthetic training data may be an exercise. The training data may comprise position of a virtual actor and one or more labels. Additionally, the training data may comprise images and/or videos of the virtual actor. In step 620, pose extraction may occur. That is, the virtual actor may be posed and/or positioned. In step 630, pose transformation may occur next. The pose transformation may convert normalized joint positions into data and/or information that provides a better indication of performance. In step 640, the neural network may be trained, for example, using any of the techniques described herein. For example, a recognition model may be created based on a plurality of positions of a single movement (e.g., exercise). In step 650, live data may be used to validate model positions. The live data may comprise videos, webcam feeds, or sample images. In step 660, the neural network may be updated and/or fine-tuned. In other examples, the neural network may be deployed at step 660. If so, development proceeds to step 670, where the neural network may be used in one or more applications to recognize the movements and/or positions associated therewith. The neural network may comprise a state machine to keep track of the plurality of positions. The state machine may help a mobile application count repetitions and/or provide feedback on the form of the exercise. In step 680, the neural network may be used to count exercise repetitions, for example, as part of a mobile and/or web application.

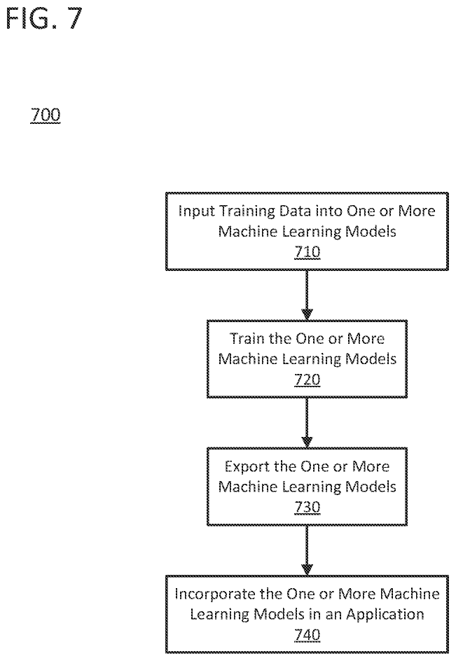

To further expand on the development process, FIG. 7 provides additional details regarding a process 700 for training a machine learning model using the synthetic training data according to one or more aspects of the disclosure. Some or all of the steps of process 700 may be performed using one or more computing devices as described herein, including, for example, the first user device 110, the second user device 120, or the server 130 or any combination thereof.

In step 710, a computing device may receive input to train one or more machine learning models. The input may comprise the training data as described above with respect to FIG. 3. Specifically, the training data may comprise one or more images of a movement and one or more labels identifying the movement and a position (state) of a virtual actor performing the movement. The one or more machine learning models may comprise a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. Additionally or alternatively, the machine learning model may comprise one or more decisions trees, such as those generated and/or trained using C4/5 or XGBoost.

In step 720, the computing device may train the one or more machine learning models, for example, using the training data. The one or more machine learning models may be trained to recognize, identify, derive, or extract features from one or more base features in the training data. As noted above, the extracted features may comprise changes in limb length, limb velocity, joint angle, and/or joint velocity for various movements from a plurality of angles and/or camera positions. The one or more machine learning models may be trained to detect a plurality of body points. For example, Posenet may detect 17 body points, while BlazePose may detect 33 body points. The systems described herein may support a highly variable number of body points and the algorithms may be resilient with respect to the quantity of body points recognized. The one or more machine learning models may be trained using supervised learning, unsupervised learning, back propagation, transfer learning, stochastic gradient descent, learning rate decay, dropout, max pooling, batch normalization, long short-term memory, skip-gram, or any equivalent deep learning technique.

Additionally or alternatively, the computing device may train the one or more machine learning models to recognize one or more objects. The one or more objects may comprise a barbell, a dumbbell, a kettlebell, or any other suitable gym equipment. By training the one or more machine learning models to detect and/or recognize one or more objects, the one or more machine learning model may detect the movement being performed by a non-virtual actor. That is, detecting one or more objects may help the one or more machine learning models differentiate between exercises that have the same, or similar, movements. For example, a standard squat may use a barbell, whereas a thruster (e.g., a combination of a squat and a shoulder press) may use dumbbells, instead. By using object detection, the one or more machine learning models may identify the movement being performed by the non-virtual actor.

Training the one or more machine learning models may include additional enhancements that help the one or more machine learning models (e.g., state machine models) exclude certain features, elements, and/or conditions that could result in false-positives. For example, debouncing may be applied to the one or more machine learning models. Debouncing may act as a type of filter that removes noise, such as anomalous inputs that may occur in a single frame (or a short sequence of frames). Debouncing may be applied to transitions in state machines, such as, when a user changes direction while performing a squat, push-up, pull-up, etc. It will be appreciated that other filtering and/or de-noising techniques could be implemented in addition to or alternatively to the debouncing described above.

Once the one or more machine learning models are trained, the one or more machine learning models may be exported in step 730. Exporting the one or more machine learning models may comprise generating an application, executable, library, API, software development kit (SDK), etc. that may be incorporated in another application and/or app. In step 740, the one or more machine learning models may be incorporated into an application so that the application may use the one or more machine learning models to recognize non-virtual actor's movements. In some instances, the one or more trained machine learning models may be transmitted from a server to one or more computing devices, such as a client computing device or an app developer's computing device.

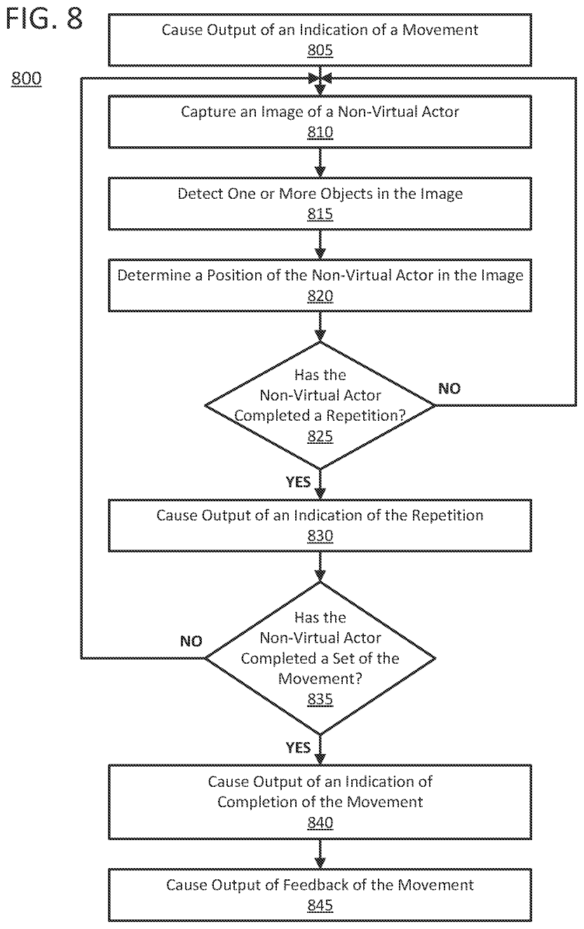

Once incorporated in an application, the one or more machine learning models may be used to detect movements, count repetitions, and/or provide feedback to a user to correct their form and improve performance. FIG. 8 shows an example of a process 800 for recognizing movements in accordance with one or more aspects of the disclosure. Some or all of the steps of process 800 may be performed using one or more computing devices as described herein, including, for example, the first user device 110, the second user device 120, or the server 130 or any combination thereof.

In step 805, a computing device may cause an output to be displayed that indicates a movement to be performed by a non-virtual actor. In some instances, an indication of the movement may be captured prior to an image of the non-virtual actor being taken. Alternatively, an output of the movement may be skilled and the computing device may capture an image of the non-virtual actor in step 810. The image may be captured using an image capture device of the computing device. Additionally or alternatively, the image may be captured using an image capture device connected or linked to the computing device. Based on the captured image, the computing device may detect (determine) the movement being performed by the non-virtual actor, for example, using the one or more machine learning models described above.

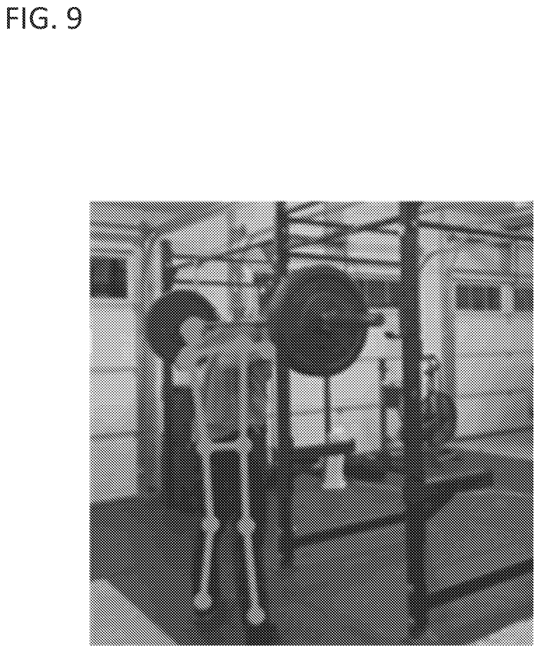

After an image of the non-virtual actor is captured in step 810, the image may be analyzed using one or more image analysis techniques. For example, in step 815, the image may be analyzed to detect one or more objects in the image. If any objects are detected, a bounding box and/or label may be applied to each of the one or more objects in the image. As noted above, one or more machine learning models may be trained to identify (recognize) one or more objects, such as barbells, dumbbells, kettlebells, or any other suitable gym equipment. The one or more objects may also comprise other objects, such as dance equipment, physical therapy equipment, boxes, etc. Detecting one or more objects may aid in determining (detecting) the movement being performed by the non-virtual actor. In step 820, the image may be analyzed to determine a position of the non-virtual actor in the image. For example, the image analysis may extract one or more features from the image. The features may include body landmarks and/or landmark vectors. The body landmarks may include identification of a head, torso, limbs of the non-virtual actor. The body landmarks may include identification of one or more joints. The landmark vectors may include limb length for each identified limb, limb velocity for each identified limb, joint angles for each identified joint, joint velocity for each identified joint, etc. FIG. 9 shows an example of the computing device detecting body landmarks of a non-virtual actor according to one or more aspects of the disclosure. The example shown in FIG. 9 illustrates a non-virtual actor (e.g., a user) in the starting position of a squat. As noted above, one or more image analysis techniques may recognize the landmarks and/or landmark vectors. The one or more machine learning models may recognize, based on the landmarks and/or landmarks vectors, that the non-virtual actor depicted in FIG. 9 is in a starting position of a squat. In some instances, the image analysis techniques used by the computing device and/or the one or more machine learning models may overlay a wireframe on the non-virtual actor. The overlay may assist in detecting changes in landmarks and/or landmark vectors, such as limb length, limb velocity, joint angle, joint velocity, and the like.

In step 825, the computing device may determine whether the non-virtual actor has completed a repetition of the movement. This determination may be based on an evaluation of the non-virtual actor's position and/or the position of the one or more objects in a plurality of images. Further, the determination may be based on whether the repetition complies with competitive rules and/or guidelines for completing a repetition. In this regard, the computing device may provide the non-virtual actor with an option to choose strict repetition counting or loose repetition counting. Strict repetition counting would evaluate repetitions to ensure that the movement met competition criteria. In this regard, the one or more machine learning models may comprise rules to evaluate the non-virtual actor's movements. If the movement did not meet competition guidelines, then the repetition that did not comply with competitive guidelines would not count. This would allow a non-virtual actor to better understand how they measure up to competitors. The loose repetition guideline may count all repetitions, but flag those that did not comply with competitive rules and/or guidelines. The computing device may then indicate which repetitions did not comply with competitive rules and/or guidelines. The computing device may provide guidance on how to improve form such that those repetitions would satisfy competitive rules and/or guidelines.

If the computing device does not have enough information to determine whether the user has completed a repetition, process 800 may return to step 810, where more images are obtained and analyzed using the steps described above. Additionally or alternatively, when the computing device determines that the non-virtual actor has not completed a repetition, the process 800 also returns to step 810, where additional images are captured and analyzed using the techniques described above. In this regard, the computing device may capture a second image of the non-virtual actor, detect one or more objects, the change between the one or more objects in the first image and the one or more objects in the second image, and determine a second position of the non-virtual actor in the second image.

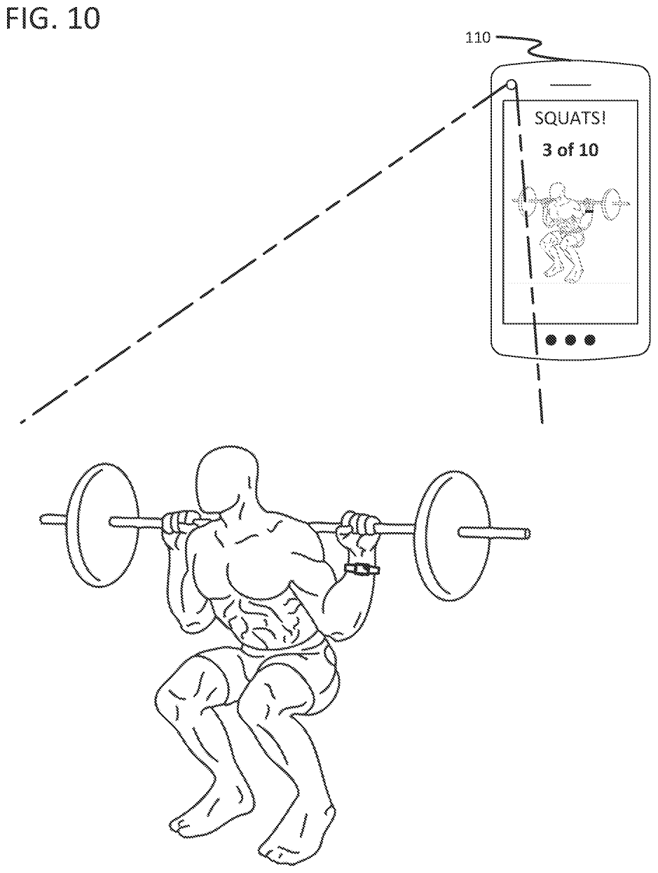

If the computing device determines that the non-virtual actor has completed a repetition of the movement, the computing device may cause an output to be displayed in step 830. The output may comprise an indication that the user has completed a repetition of the movement. An example of an output that may be displayed is shown in FIG. 10. In step 835, the computing device may determine whether the non-virtual actor has completed a set of the movement. If the non-virtual actor has not completed a set of the movement, then process 800 returns to step 810 to evaluate the next repetition of the movement. However, if the non-virtual actor has completed a set of the movement, then the computing device may proceed to step 840, where the computing device causes output of an indication of that a set of the movement has been completed. In step 845, the computing device may provide feedback to the non-virtual actor to improve their form and/or their performance.

It will be appreciated that process 800 may be repeated for a predetermined number of sets of the movement. Accordingly, the computing device may keep track of the number of sets that the non-virtual actor completes. When the non-virtual actor completes the predetermined number of sets, the computing device may cause an output to displayed that indicates that the non-virtual actor has completed

As noted above, FIG. 10 shows an example of the output that may be displayed as a result of process 800. For example, FIG. 10 shows a user device, such as first user device 110, which may have a mobile application installed thereon. Using the techniques described herein, the mobile application may activate a forward-facing camera on the user device. The mobile application may provide the user with a guided workout as described above. For example, the mobile application may prompt the user to perform squats in step 805. Using the forward-facing camera, the mobile application may capture one or more images and recognize the user's movements to determine the user's form, provided feedback on the user's form, and/or count repetitions and/or sets. In addition to the mobile application, a user may use an auxiliary device (e.g., a fitness tracker, weight-mounted sensors, etc.) that may provide additional information to the mobile application. The additional information may comprise user information, such as heart rate, breathing rate, etc. Additionally or alternatively, the additional information may provide signals during the course of the workout that could be used to assist with repetition counting and/or to understand the user's body position more accurately. The auxiliary devices may comprise wearable devices, such as smart watches to monitor biometric data, acceleration, position, etc. Additionally or alternatively, the auxiliary devices may comprise smart equipment, such as smart cardiovascular equipment (e.g., a treadmill, an elliptical machine, a stationary bike, a spin bike, etc.) or a bar that provides acceleration, orientation data, etc.

It will be appreciated that the user device may sync with a television, or equivalent monitor, to display the user and/or a coach, as well as the user's status or performance summary. In this regard, a mobile device may connect to a television or monitor using any wired or wireless connection. An image capture device of the mobile device may capture an image of the user and provide the display of the user to the television or monitor. The application may also provide a video or animation to the television, in addition to the user's status and/or performance summary. The user may then view themselves, as well as a trainer or coach and their performance summary (e.g., the exercise being performed, the number of repetitions, which set is being performed, timing for the set, a status of the user compared to other athletes, a ranking of the user compared to other athletes/competitors).

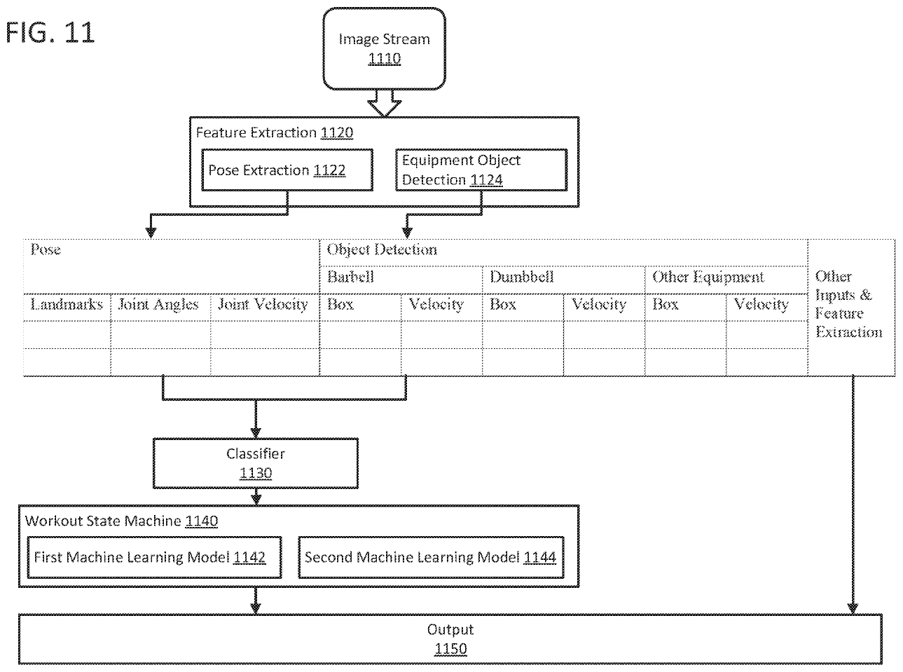

The examples described above provide repetition and set counting for a single movement. As a user becomes capable of performing the single movement, the user may want to challenge themselves with supersets, high-impact intensity training, or other exercise regimens that incorporate varied functional movements performed at high intensity (e.g., CrossFit®). FIG. 11 shows an example of performing a plurality of movements in accordance with one or more aspects of the disclosure.

Similar to the techniques described above, a computing device may receive image stream 1110. The image stream 1110 may be one or more photos of a non-virtual actor. Alternatively, the image stream 110 may be a video or animation of a non-virtual actor. A feature extraction unit 1120 receives the image stream 1110. The feature extraction unit 1120 may comprise a pose extraction unit 1122 and an equipment object detection unit 1124. The pose extraction unit 1122 may analyze each of the images in the image stream 1110 to recognize (extract) body landmarks, such as user's head, torso, limbs, or joints, and landmark vectors, such as limb length, limb velocity, joint angles, or joint velocity. The pose extraction unit 1122 may overlay a wireframe or skeleton over a user depicted in the image stream 1110. This may assist the feature extraction unit 1120 and/or the pose extraction unit 1122 to detect changes in landmarks and/or landmark vectors. The equipment object detection unit 1124 may also analyze the image stream 1110 to recognize objects in the image stream 1110. As noted above, the objects may include dumbbells, barbells, kettlebells, dance equipment, physical therapy equipment, boxes, etc. The data and/or information extracted by pose extraction unit 1122 and equipment object detection unit 1124 may be stored in a table, such as the one depicted in FIG. 11. Classifier 1130 may be a scalable, distributed gradient-boosted decision tree, such as XGBoost. Classifier 130 may be configured to read the data and/or information from the table to apply labels to each of the images in the image stream 1110. The labels and the images may be provided to workout state machine 1140. Workout state machine 1140 may comprise a first machine learning model 1142 and a second machine learning model 1144 executing in parallel. Additionally or alternatively, the first machine learning model 1142 may comprise a first state machine and the second machine learning model 1144 may comprise a second state machine. Using the techniques described above, the first machine learning model 1142 and a second machine learning model 1144 may detect movements performed by the non-virtual actor, count repetitions, and/or provide feedback and suggestions for improving the non-virtual actor's movements and overall performance. As an example, the workout state machine 1140 may be configured to track a non-virtual actor's performance of the Fran workout. The Fran workout is a couplet of exercises, including barbell thrusters (e.g., a front squat and push-press combo) and pull-ups. A non-virtual actor performs three rounds of each exercise, with each subsequent round decrementing the number of repetitions needed to be performed. In the first round, the non-virtual actor may perform 21 repetitions of barbell thrusters followed up 21 repetitions of pull-ups. In the next round, the non-virtual actor may perform 15 repetitions of barbell thrusters followed up 15 repetitions of pull-ups. In the final round, the non-virtual actor may perform 9 repetitions of barbell thrusters followed up 9 repetitions of pull-ups. The Fran workout is often done for time (e.g., how quickly can it be completed). Because the workout state machine 1140 is configured for the Fran workout, the first machine learning model 1142 may comprise a first machine learning model configured to identify barbell thrusters and the second machine learning model 1144 may comprise a second machine learning model configured to identify pull-ups. Accordingly, the first machine learning model 1142 may use process 800, or a process similar thereto, to identify and count repetitions of barbell thrusters. Similarly, the second machine learning model 1144 may use the process 800, or a process similar thereto, to identify and count repetitions of pull-ups. A performance summary may be outputted in 1150. The performance summary may include repetition counts, repetition timing, an identification of repetitions that did not count, form correctness, and/or suggestions for improving performance. The output 1150 may be presented as an overlay of the non-virtual actor's workout performance. In some instances, the output 1150 may step through the non-virtual actor's repetitions to show where their form was incorrect or could be improved. Additionally, the output 1150 may indicate which repetitions did not comply with competition rules and would, therefore, not count if performed in a competition.

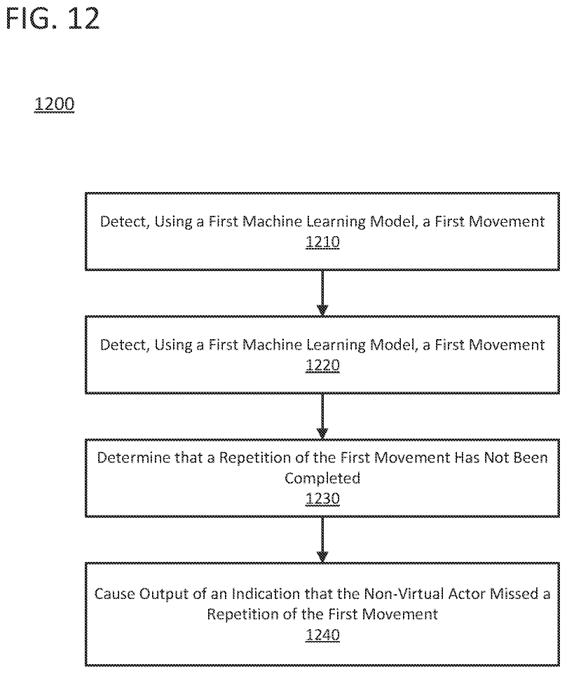

Due to the changes in movements, the computing device may have to detect changes in movements, as well as repetitions that may be missed while changing movements. FIG. 12 shows an example process 1200 for detecting missed repetitions in accordance with one or more aspects of the disclosure. Some or all of the steps of process 800 may be performed using one or more computing devices as described herein, including, for example, the first user device 110, the second user device 120, or the server 130 or any combination thereof.

In step 1210, the computing device may detect a first movement by a non-virtual actor. The first movement may be detected using a first machine learning model. Additionally, the first movement may be detected using any of the techniques described above. In particular, the first movement may be detected based on at least one of a movement of the non-virtual actor or a pose of the non-virtual actor. Once the first movement is detected, the computing device may determine whether the non-virtual actor has completed a first repetition of the movement, for example, using the first machine learning model.

In step 1220, the computing device may detect a second movement by the non-virtual actor. The second movement is different from the first movement. The second movement may be detected using a second machine learning model executing in parallel with the first machine learning model. Once the second movement is detected, the computing device may determine whether the non-virtual actor has completed a repetition of the second movement using the techniques described above.

In step 1230, the computing device may determine that the non-virtual actor did not complete at least one repetition of the first movement before beginning the second movement. In this regard, the computing device may have missed one or more repetitions of the first movement. Additionally or alternatively, the computing device may determine that one or more repetitions of the first movement did not count because the one or more repetitions did not meet competitive rules for completion of the repetition. As noted above, the non-virtual actors may set performance rules related to when repetitions count. Looser rules may count all repetitions and flag those that may not meet competitive guidelines. The computing device may indicate which repetitions did not conform (comport) with competitive guidelines. The computing device may provide guidance on how to improve form such that those repetitions would satisfy competitive guidelines. Stricter rules would not count the repetitions that did not conform (comport) with competitive guidelines. This would allow a non-virtual actor to better understand how they measure up to competitors. In step 1240, the computing device may cause output of a performance summary. The performance summary may indicate that the non-virtual actor missed a repetition of a first movement. As noted above, the performance summary may provide the number of repetitions performed, any repetitions that were missed and why the repetitions were missed, a timing for the workout, etc.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like, that perform particular tasks or implement particular abstract data types when executed by a processor in a computer or other device. The modules may be written in a source code programming language that is subsequently compiled for execution, or may be written in a scripting language such as (but not limited to) HTML, XML, Typescript, Javascript, Python or Ruby. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

What is claimed is:

1. A method for automatically counting repetitions of an exercise movement using one or more machine learning models trained using synthetic training data, the method comprising:
generating the synthetic training data for the one or more machine learning models using a virtual actor performing the exercise movement and using one or more virtual cameras;
storing the synthetic training data in a memory;
training, by a server, the one or more machine learning models using the synthetic training data;
transmitting, from the server to a computing device, the trained one or more machine learning models;
capturing, by the image capture device of the computing device, a first image of the non-virtual actor performing the exercise movement;
determining, using the trained one or more machine learning models, a first position of the non-virtual actor in the first image;
capturing, by the image capture device of the computing device, a second image of the non-virtual actor;
determining, using the trained one or more machine learning models, a second position of the non-virtual actor in the second image;
determining, based on a change from the first position to the second position, that the non-virtual actor has completed a repetition of the exercise movement; and
causing one or both of an audio or visual output of an indication of the repetition of the exercise movement.

2. The method of claim 1, wherein the generating the synthetic training data comprises:
placing the virtual actor in a first pose indicative of a starting position of a repetition of the exercise movement;
capturing, using one or more virtual cameras, a first plurality of images of the virtual actor in the first pose, wherein the first plurality of images are captured from different angles and different perspectives;
placing the virtual actor in a second pose indicative of a mid-point of the repetition of the exercise movement;
capturing, using the one or more virtual cameras, a second plurality of images of the virtual actor in the second pose, wherein the second plurality of images are captured from different angles and different perspectives;
placing the virtual actor in a third pose indicative of a finishing position of the repetition of the exercise movement; and
capturing, using the one or more virtual cameras, a third plurality of images of the virtual actor in the third pose, wherein the third plurality of images are captured from different angles and different perspectives.

3. The method of claim 2, wherein the training the one or more machine learning models using the synthetic training data comprises providing the first plurality of images, the second plurality of images, and the third plurality of images to the one or more machine learning models.

4. The method of claim 1, further comprising:
causing output, prior to capturing the first image of the non-virtual actor, of an indication of the exercise movement to be performed by the non-virtual actor.

5. The method of claim 1, further comprising:
detecting, using one or more second machine learning models, one or more objects at least the first image or the second image, wherein determining that the non-virtual actor has completed the repetition of the exercise movement is further based on detecting the one or more objects.

6. The method of claim 5, wherein the one or more objects comprise at least one of a barbell, a dumbbell, or a kettlebell.

7. The method of claim 1, wherein determining that the non-virtual actor has completed the repetition of the exercise movement is further based on a determination that the first position and the second position conform to competitive guidelines for completing a repetition of the exercise movement.

8. The method of claim 1, further comprising:
providing feedback to the non-virtual actor to improve a form of the exercise movement.

9. The method of claim 1, wherein:
the determining the first position of the non-virtual actor is based on at least one of a first limb length, a first limb velocity, a first joint angle, or a first joint velocity; and
the determining the second position of the non-virtual actor is based on at least one of a second limb length, a second limb velocity, a second joint angle, or a second joint velocity.

10. The method of claim 1, further comprising:
determining, using one or more second machine learning models, a third position of the non-virtual actor;
determining, using the one or more second machine learning models, a fourth position of the non-virtual actor;
determining, based on the third position and based on the fourth position, that the non-virtual actor has completed a second repetition of a second exercise movement, wherein the second exercise movement is different from the exercise movement; and
causing output of an indication of a repetition of the second exercise movement.

11. A method for automatically tracking a first exercise movement and a second exercise movement using one or more machine learning models trained using synthetic training data, the method comprising:
determining, by a computing device using a first machine learning model, that a non-virtual actor has completed a first repetition of the first exercise movement;
determining, using a second machine learning model executing in parallel with the first machine learning model, that the non-virtual actor has completed a second repetition of the second exercise movement, wherein the second exercise movement is different from the first exercise movement; and
causing output of an indication of a complete set, wherein the complete set comprises a first predetermined number of repetitions of the first exercise movement and a second predetermined number of repetitions of the second exercise movement.

12. The method of claim 11, wherein determining that the non-virtual actor has completed the first repetition of the first exercise movement is based on detecting the one or more objects.

13. The method of claim 11, further comprising:
detecting, using the first machine learning model and prior to determining that the non-virtual actor has completed the first repetition, the first exercise movement based on at least one of a movement of the non-virtual actor or a pose of the non-virtual actor.

14. The method of claim 11, further comprising:
detecting, using the second machine learning model and prior to determining that the non-virtual actor has completed a third repetition, the second exercise movement based on at least one of a movement of the non-virtual actor or a pose of the non-virtual actor;
determining whether the non-virtual actor completed a third predetermined number of repetitions of the first exercise movement prior to detecting the second exercise movement; and
based on a determination that the non-virtual actor had not completed the third predetermined number of repetitions of the first exercise movement prior to detecting the second exercise movement, causing output of an indication that the third predetermined number of repetitions of the first exercise movement were not completed.

15. The method of claim 14, wherein the determination that the non-virtual actor had not completed the third predetermined number of repetitions of the first exercise movement prior to detecting the second exercise movement is based on a determination that at least one repetition did not conform to competitive guidelines for the first exercise movement.

16. A computing device for automatically tracking a first exercise movement and a second exercise movement using one or more machine learning models trained using synthetic training data, the computing device comprising:
one or more processors; and
memory storing instructions that, when executed by the one or more processors, cause the computing device to:
determine, using a first machine learning model, that a non-virtual actor has completed a first repetition of the first exercise movement;
determine, using a second machine learning model executing in parallel with the first machine learning model, that the non-virtual actor has completed a second repetition of the second exercise movement, wherein the second exercise movement is different from the first exercise movement; and
cause output of an indication of a complete set, wherein the complete set comprises a first predetermined number of repetitions of the first exercise movement and a second predetermined number of repetitions of the second exercise movement.

17. The computing device of claim 16, wherein the instructions, when executed by the one or more processors cause the computing device to determine that the non-virtual actor has completed the first repetition of the first exercise movement based on detecting the one or more objects.

18. The computing device of claim 16, wherein the instructions, when executed by the one or more processors cause the computing device to:
detect, using the first machine learning model and prior to determining that the non-virtual actor has completed the first repetition, the first exercise movement based on at least one of a movement of the non-virtual actor or a pose of the non-virtual actor.

19. The computing device of claim 16, wherein the instructions, when executed by the one or more processors cause the computing device to:
detect, using the second machine learning model and prior to determining that the non-virtual actor has completed a third repetition, the second exercise movement based on at least one of a movement of the non-virtual actor or a pose of the non-virtual actor;
determine whether the non-virtual actor completed a third predetermined number of repetitions of the first exercise movement prior to detecting the second exercise movement; and
based on a determination that the non-virtual actor had not completed the third predetermined number of repetitions of the first exercise movement prior to detecting the second exercise movement, cause output of an indication that the third predetermined number of repetitions of the first exercise movement were not completed.

20. The computing device of claim 19, wherein the instructions, when executed by the one or more processors cause the computing device to determine that the non-virtual actor had not completed the third predetermined number of repetitions of the first exercise movement prior to detecting the second exercise movement based on a determination that at least one repetition did not conform to competitive guidelines for the first exercise movement.
